(19) United States
(12) Patent Application Publication
(10) Pub. No.: US 2024/0113330 A1
(43) Pub. Date: Apr. 4, 2024

(54) BATTERY AND SOLID-STATE BATTERY

(71) Applicant: Panasonic Intellectual Property Management Co., Ltd., Osaka (JP)

(72) Inventor: YASUTAKA TSUTSUI, Osaka (JP)

(21) Appl. No.: 18/527,313

(22) Filed: Dec. 3, 2023

Related U.S. Application Data
(63) Continuation of application No. PCT/JP2022/021168, filed on May 24, 2022.

(30) Foreign Application Priority Data
Jun. 9, 2021 (JP) 2021-096779

(51) Int. Cl. H01M 10/0562; H01M 10/058

(52) U.S. Cl. CPC H01M 10/0562; H01M 10/058; H01M 2300/008

(57) ABSTRACT

A battery includes a positive electrode active material layer, a negative electrode active material layer, and a solid electrolyte layer located therebetween. The battery satisfies Requirement (i) or Requirement (ii). (i) At least one layer selected from the group consisting of the positive electrode active material layer, the negative electrode active material layer, and the solid electrolyte layer contains a halide solid electrolyte and a sulfide solid electrolyte, and a mass ratio of the sulfide solid electrolyte to a total of the above-described three layers is less than or equal to 1%. (ii) At least one layer selected from the group consisting of the positive electrode active material layer, the negative electrode active material layer, and the solid electrolyte layer contains a halide solid electrolyte and an odorant, and a mass ratio of the odorant to a total of the above-described three layers is less than or equal to 1%.

### BACKGROUND

### 1. Technical Field

The present disclosure relates to a battery and a solid-state battery.

### 2. Description of the Related Art

Japanese Unexamined Patent Application Publication No. 2006-244734 discloses a battery that uses, as a solid electrolyte, a compound containing indium serving as a cation and containing a halogen element serving as an anion.

### SUMMARY

Regarding the related art, it is desired to further improve the safety of a battery.

In one general aspect, the techniques disclosed here feature a battery including a positive electrode active material layer, a negative electrode active material layer, and a solid electrolyte layer located between the positive electrode active material layer and the negative electrode active material layer, wherein Requirement (i) or Requirement (ii) below is satisfied, (i) at least one layer selected from the group consisting of the positive electrode active material layer, the negative electrode active material layer, and the solid electrolyte layer contains a halide solid electrolyte and a sulfide solid electrolyte, and a ratio of the mass of the sulfide solid electrolyte to a total mass of the positive electrode active material layer, the negative electrode active material layer, and the solid electrolyte layer is less than or equal to 1%, or (ii) at least one layer selected from the group consisting of the positive electrode active material layer, the negative electrode active material layer, and the solid electrolyte layer contains a halide solid electrolyte and an odorant, and a ratio of the mass of the odorant to a total mass of the positive electrode active material layer, the negative electrode active material layer, and the solid electrolyte layer is less than or equal to 1%.

According to the present disclosure, the safety of the battery can be further improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view illustrating the configuration of a battery according to a first embodiment; and

FIG. 2 is a schematic sectional view illustrating the configuration of a solid-state battery according to a second embodiment.

### DETAILED DESCRIPTIONS

### Underlying Knowledge Forming Basis of the Present Disclosure

According to research in recent years, a sulfide solid electrolyte may burn under a specific condition. A sulfide solid electrolyte may react with moisture in the air so as to generate hydrogen sulfide. However, since hydrogen sulfide is readily detected, there is a merit that leakage of the content can be readily detected when the container of a battery is damaged or deteriorates.

A halide solid electrolyte does not readily burn under the above-described specific condition. Therefore, a battery including a halide solid electrolyte as the solid electrolyte has excellent safety compared with a battery including a sulfide solid electrolyte. However, since the halide solid electrolyte is odorless, there is a problem that leakage of the content is not readily detected when the container of a battery is damaged or deteriorates.

The present inventor performed intensive research on a method for further improving the safety of a battery including a halide solid electrolyte. As a result, it was found that leakage of an electrolyte can be detected early by adding a very small amount of an odorant such as a sulfide solid electrolyte.

### Outline of Aspect According to the Present Disclosure

A battery according to a first aspect of the present disclosure includes:
a positive electrode active material layer;
a negative electrode active material layer; and
a solid electrolyte layer located between the positive electrode active material layer and the negative electrode active material layer,
wherein Requirement (i) or Requirement (ii) below are satisfied,
(i) at least one layer selected from the group consisting of the positive electrode active material layer, the negative electrode active material layer, and the solid electrolyte layer contains a halide solid electrolyte and a sulfide solid electrolyte, and
a ratio of the mass of the sulfide solid electrolyte to a total mass of the positive electrode active material layer, the negative electrode active material layer, and the solid electrolyte layer is less than or equal to 1%, or
(ii) at least one layer selected from the group consisting of the positive electrode active material layer, the negative electrode active material layer, and the solid electrolyte layer contains a halide solid electrolyte and an odorant, and
a ratio of the mass of the odorant to a total mass of the positive electrode active material layer, the negative electrode active material layer, and the solid electrolyte layer is less than or equal to 1%.

According to the above-described configuration, leakage of the electrolyte and the like can be detected early using the odorant such as the sulfide solid electrolyte. For example, when a battery contains the sulfide solid electrolyte, if the sulfide solid electrolyte leaks outside the battery, the sulfide solid electrolyte reacts with moisture in the air so as to generate hydrogen sulfide. Since hydrogen sulfide has a rotten-egg odor, leakage can be readily detected due to the odor. Therefore, the safety of the battery can be improved.

In a second aspect of the present disclosure, for example, regarding Requirement (i) with respect to the battery according to the first aspect, the ratio of the mass of the sulfide solid electrolyte to the total mass of the positive electrode active material layer, the negative electrode active material layer, and the solid electrolyte layer may be less than or equal to 0.1%. According to the above-described configuration, the safety of the battery can be improved.

In a third aspect of the present disclosure, for example, regarding Requirement (i) with respect to the battery according to the first aspect, the ratio of the mass of the sulfide solid electrolyte to the total mass of the positive electrode active material layer, the negative electrode active material layer, and the solid electrolyte layer may be less than or equal to 0.01%. According to the above-described configuration, the safety of the battery can be improved.

In a fourth aspect of the present disclosure, for example, regarding Requirement (i) with respect to the battery according to any one of the first aspect to the third aspect, the sulfide solid electrolyte may contain at least one selected from the group consisting of Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. According to the above-described configuration, the ionic conductivity of the sulfide solid electrolyte can be improved.

In a fifth aspect of the present disclosure, for example, regarding Requirement (ii) with respect to the battery according to the first aspect, the odorant may be a substance having no lithium ion conductivity. According to the above-described configuration, the safety of the battery can be improved.

In a sixth aspect of the present disclosure, for example, the halide solid electrolyte in the battery according to any one of the first aspect to the fifth aspect may contain at least one selected from the group consisting of Li, metal elements other than Li, and semimetals and at least one selected from the group consisting of F, Cl, Br, and I. According to the above-described configuration, the ionic conductivity of the halide solid electrolyte can be improved.

In a seventh aspect of the present disclosure, for example, the halide solid electrolyte in the battery according to the sixth aspect may be denoted by Formula (1):

L_{α}MβX_{γ} (1)
where α, β, and γ each represent a value greater than 0,
M represents at least one selected from the group consisting of metal elements other than Li and semimetals, and
X represents at least one selected from the group consisting of F, Cl, Br, and I. According to the above-described configuration, the ionic conductivity of the halide solid electrolyte can be further improved.

In an eighth aspect of the present disclosure, for example, in Formula (1) with respect to the battery according to the seventh aspect, M may include yttrium. According to the above-described configuration, the ionic conductivity of the halide solid electrolyte can be further improved.

A solid-state battery according to a ninth aspect of the present disclosure includes:
a casing having an internal space;
a power generator disposed in the internal space, and
an odorant disposed outside the power generator in the internal space.

According to the above-described configuration, leakage of the electrolyte and the like from the power generator can be detected early using the odorant. Accordingly, the safety of the solid-state battery can be improved.

In a tenth aspect of the present disclosure, for example, the odorant in the solid-state battery according to the ninth aspect may be solid.

In an eleventh aspect of the present disclosure, for example, the odorant in the solid-state battery according to the ninth aspect or the tenth aspect may contain a sulfide solid electrolyte. The sulfide solid electrolyte has a function of improving the output characteristics of the solid-state battery. Therefore, according to the above-described configuration, the performance of the solid-state battery is suppressed from deteriorating due to addition of the odorant. Consequently, the safety of the solid-state battery can be improved while the performance of the solid-state battery is maintained.

In a twelfth aspect of the present disclosure, for example, the solid-state battery according to any one of the ninth aspect to the eleventh aspect may further include a first collector disposed on the power generator and a second collector disposed under the power generator, wherein the odorant may be disposed on the first collector. According to the above-described configuration, the odorant does not readily affect the characteristics of the solid-state battery.

The embodiments according to the present disclosure will be described below with reference to the drawings.

### First Embodiment

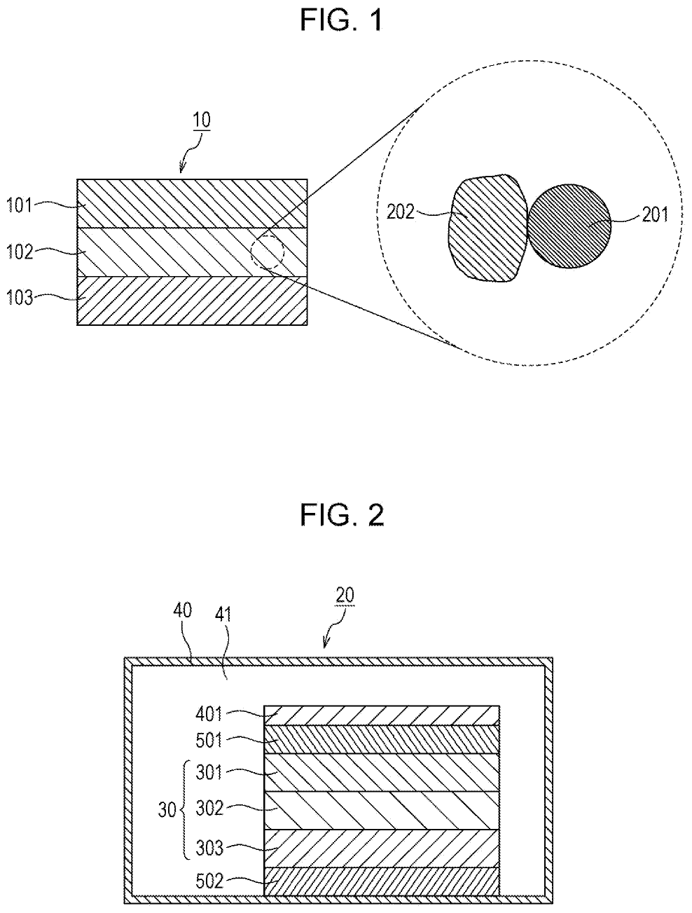

FIG. 1 is a schematic sectional view illustrating the configuration of a battery 10 according to a first embodiment.

The battery 10 includes a positive electrode active material layer 101, a negative electrode active material layer 103, a solid electrolyte layer 102 located between the positive electrode active material layer 101 and the negative electrode active material layer 103. The battery 10 satisfies Requirement (i) or Requirement (ii) below.
(i) At least one layer selected from the group consisting of the positive electrode active material layer 101, the negative electrode active material layer 103, and the solid electrolyte layer 102 contains a halide solid electrolyte 201 and a sulfide solid electrolyte 202, and a ratio of the mass of the sulfide solid electrolyte 202 to a total mass of the positive electrode active material layer 101, the negative electrode active material layer 103, and the solid electrolyte layer 102 is less than or equal to 1%.
(ii) At least one layer selected from the group consisting of the positive electrode active material layer 101, the negative electrode active material layer 103, and the solid electrolyte layer 102 contains a halide solid electrolyte 201 and an odorant, and a ratio of the mass of the odorant to a total mass of the positive electrode active material layer 101, the negative electrode active material layer 103, and the solid electrolyte layer 102 is less than or equal to 1%.

In the present disclosure, “odor” means an odor sensible by the human sense of smell or detectable by a detection device. “Odorant” means a substance which itself has an odor or a substance which emits an odor due to a reaction with moisture in the air when the substance leaks outside the battery 10. An example of the former is sulfur dioxide. An example of the latter is the sulfide solid electrolyte 202. “Odorant” may be a low-molecular-weight compound containing a sulfur atom or a nitrogen compound such as ammonia or trimethylamine.

According to the above-described configuration, leakage of the electrolyte and the like can be detected early using an odorant such as the sulfide solid electrolyte 202. For example, when the battery 10 contains the sulfide solid electrolyte 202 as the odorant, if the sulfide solid electrolyte 202 leaks outside the battery 10, the sulfide solid electrolyte 202 reacts with moisture in the air so as to generate hydrogen sulfide. Since hydrogen sulfide has a rotten-egg odor, leakage can be readily detected due to the odor. When leakage is detected, charge or discharge of the battery 10 is promptly stopped, and the occurrence of the malfunction can be notified to the outside. Therefore, the safety of the battery 10 can be improved. In this regard, FIG. 1 illustrates the example in which the solid electrolyte layer 102 contains the halide solid electrolyte 201 and the sulfide solid electrolyte 202.

It is predicted that when the odorant is added to the battery, the performance of the battery deteriorates with increasing amount of the odorant added. However, the sulfide solid electrolyte has high ionic conductivity and, therefore, has a function of improving the output characteristics of the battery. Consequently, when Requirement (i) is satisfied, the performance of the battery 10 is suppressed from deteriorating due to the sulfide solid electrolyte being added. As a result, the safety of the battery 10 can be improved while the performance of the battery 10 is maintained. In this regard, when Requirement (ii) is satisfied, since the ratio of the odorant is low, the safety of the battery 10 can be improved while the performance of the battery 10 is suppressed from deteriorating.

The ratio of the mass of the sulfide solid electrolyte 202 to the total mass of the positive electrode active material layer 101, the negative electrode active material layer 103, and the solid electrolyte layer 102 can be calculated by, for example, the following method. The outline of the sulfide solid electrolyte 202 is extracted from the SEM images of the cross sections of the positive electrode active material layer 101, the negative electrode active material layer 103, and the solid electrolyte layer 102, and the area is calculated. Subsequently, the radius (equivalent circle radius) of a circle having an area equivalent to the resulting area is calculated. The sulfide solid electrolyte 202 is assumed to be a perfect sphere having the calculated equivalent circle radius, and the volume of the sulfide solid electrolyte 202 can be calculated from the equivalent circle radius. The volume of each of a plurality of sulfide solid electrolytes 202 included in the positive electrode active material layer 101, the negative electrode active material layer 103, and the solid electrolyte layer 102 is calculated in the method akin to that described above. The sum of the resulting values is the total volume of the sulfide solid electrolyte 202 included in the positive electrode active material layer 101, the negative electrode active material layer 103, and the solid electrolyte layer 102. The density of the sulfide solid electrolyte 202 can be known from literature and the like. The ratio of the mass of the sulfide solid electrolyte 202 to the total mass of the positive electrode active material layer 101, the negative electrode active material layer 103, and the solid electrolyte layer 102 can be calculated from these values.

The ratio of the mass of the odorant to the total mass of the positive electrode active material layer 101, the negative electrode active material layer 103, and the solid electrolyte layer 102 can be calculated by, for example, the following method. The odorant included in the positive electrode active material layer 101, the negative electrode active material layer 103, and the solid electrolyte layer 102 can be taken out by, for example, dissolving the solid electrolyte and the like included in these layers by using a solvent and, thereafter, removing the positive electrode active material and the negative electrode active material. The total mass of the positive electrode active material layer 101, the negative electrode active material layer 103, and the solid electrolyte layer 102 and the mass of the odorant can be known from the masses before and after the above-described taking out. From these values, the ratio of the mass of the odorant to the total mass of the positive electrode active material layer 101, the negative electrode active material layer 103, and the solid electrolyte layer 102 can be calculated. Alternatively, the ratio of the mass of the odorant to the total mass of the negative electrode active material layer 103 and the solid electrolyte layer 102 can be obtained by an infrared spectroscopic analysis (FT-IR analysis) method or a gas chromatography and mass spectroscopic analysis (GC-MS analysis) method.

Regarding Requirement (i), the ratio of the mass of the sulfide solid electrolyte 202 to the total mass of the positive electrode active material layer 101, the negative electrode active material layer 103, and the solid electrolyte layer 102 may be less than or equal to 0.1%. Decreasing the ratio of the sulfide solid electrolyte 202 enables the flame retardancy of the battery 10 to be further enhanced. Consequently, the safety of the battery 10 can be improved.

Regarding Requirement (i), the ratio of the mass of the sulfide solid electrolyte 202 to the total mass of the positive electrode active material layer 101, the negative electrode active material layer 103, and the solid electrolyte layer 102 may be less than or equal to 0.01%. Decreasing the ratio of the sulfide solid electrolyte 202 enables the flame retardancy of the battery 10 to be further enhanced. Consequently, the safety of the battery 10 can be improved.

Regarding Requirement (i), there is no particular limitation regarding the lower limit value of the ratio of the mass of the sulfide solid electrolyte 202 to the total mass of the positive electrode active material layer 101, the negative electrode active material layer 103, and the solid electrolyte layer 102. The lower limit value is, for example, 0.001%.

Regarding Requirement (ii), there is no particular limitation regarding the lower limit value of the ratio of the mass of the odorant to the total mass of the positive electrode active material layer 101, the negative electrode active material layer 103, and the solid electrolyte layer 102. The lower limit value is, for example, 0.001%.

Any one layer of the positive electrode active material layer 101, the negative electrode active material layer 103, and the solid electrolyte layer 102 may contain the halide solid electrolyte 201 and the sulfide solid electrolyte 202. All layers of the positive electrode active material layer 101, the negative electrode active material layer 103, and the solid electrolyte layer 102 may contain the halide solid electrolyte 201 and the sulfide solid electrolyte 202. Any two layers selected from the group consisting of the positive electrode active material layer 101, the negative electrode active material layer 103, and the solid electrolyte layer 102 may contain the halide solid electrolyte 201 and the sulfide solid electrolyte 202.

Any one layer of the positive electrode active material layer 101, the negative electrode active material layer 103, and the solid electrolyte layer 102 may contain the halide solid electrolyte 201 and the odorant. All layers of the positive electrode active material layer 101, the negative electrode active material layer 103, and the solid electrolyte layer 102 may contain the halide solid electrolyte 201 and the odorant. Any two layers selected from the group consisting of the positive electrode active material layer 101, the negative electrode active material layer 103, and the solid electrolyte layer 102 may contain the halide solid electrolyte 201 and the odorant.

As illustrated in FIG. 1, the solid electrolyte layer 102 may contain the halide solid electrolyte 201 and the sulfide solid electrolyte 202. According to the above-described configuration, the safety of the battery 10 can be further improved while the performance of the battery 10 is maintained.

Regarding Requirement (i), the sulfide solid electrolyte 202 may be a solid electrolyte having lithium ion conductivity. When the sulfide solid electrolyte 202 is a solid electrolyte having lithium ion conductivity, examples of the sulfide solid electrolyte 202 include synthetic materials composed of lithium sulfide (Li₂S) and phosphorus pentasulfide (P₂S₅).

Regarding Requirement (i), the sulfide solid electrolyte 202 may contain at least one selected from the group consisting of Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. According to the above-described configuration, the ionic conductivity of the sulfide solid electrolyte 202 can be improved.

In addition, at least one selected from the group consisting of Li₃N, LiCl, LiBr, Li₃PO₄, and Li₄SiO₄ may be added as an additive to the sulfide solid electrolyte 202.

Regarding Requirement (ii), the odorant may be a substance having no lithium ion conductivity. According to the above-described configuration, the safety of the battery 10 can be improved.

When the odorant is a substance having no lithium ion conductivity, examples of the odorant include sulfur dioxide, low-molecular-weight mercaptans, dialkyl sulfides, and dialkyl disulfides and mixtures of these. Examples of the low molecular-weight mercaptan include methyl mercaptan, ethyl mercaptan, isopropyl mercaptan, isobutyl mercaptan, and tert-butyl mercaptan. Nitrogen compounds such as ammonia and trimethylamine are also odorants having no lithium ion conductivity.

The odorant may be encapsulated in a microcapsule. The microcapsule may be configured to be thermally decomposed when an environmental temperature becomes higher than a predetermined temperature. The predetermined temperature may be, for example, 100° C.

The halide solid electrolyte 201 may be a material having lithium ion conductivity. The halide solid electrolyte 201 may contain at least one selected from the group consisting of Li, metal elements other than Li, and semimetals and at least one selected from the group consisting of F, Cl, Br, and I. According to the above-described configuration, the ionic conductivity of the halide solid electrolyte 201 can be improved.

In the present disclosure, “semimetal element” includes B, Si, Ge, As, Sb, and Te. “Metal element” includes all elements in group I to group XII of the periodic table except for hydrogen and all elements of group XIII to group XVI of the periodic table except for B, Si, Ge, As, Sb, Te, C, N, P, O, S, and Se. That is, “semimetal element” or “metal element” is a group of elements, each of which can become a cation when the element and a halogen element form an inorganic compound.

The halide solid electrolyte 201 may be a material containing no sulfur. When the halide solid electrolyte 201 contains no sulfur, a hydrogen sulfide gas is suppressed from being generated.

The halide solid electrolyte 201 may be denoted by Formula (1).

L_{α}M_{β}X_{γ} (1)

Herein, α, β, and γ each represent a value greater than 0. M represents at least one selected from the group consisting of metal elements other than Li and semimetals. X represents at least one selected from the group consisting of F, Cl, Br, and I.

The halide solid electrolyte 201 denoted by Formula (1) has high ionic conductivity compared with a halide solid electrolyte such as LiI composed of Li and a halogen element. Therefore, according to the halide solid electrolyte 201 denoted by Formula (1), the ionic conductivity of the halide solid electrolyte 201 can be further improved.

Regarding Formula (1), M may include Y (=yttrium). That is, the halide solid electrolyte 201 may contain Y as a metal element. According to the above-described configuration, the ionic conductivity of the halide solid electrolyte 201 can be further improved.

The halide solid electrolyte containing Y may be a compound denoted by, for example, a formula LiₐMe_{b}Y_{c}X₆. Herein, a+mb+3c=6 and c>0 are satisfied. Me represents at least one selected from the group consisting of metal elements except for Li and Y and semimetals. m represents a valence of element Me. X represents at least one selected from the group consisting of F, Cl, Br, and I.

Me may represent, for example, at least one selected from the group consisting of Mg, Ca, Sr, Ba, Zn, Sc, Al, Ga, Bi, Zr, Hf, Ti, Sn, Ta, and Nb.

According to the above-described configuration, the ionic conductivity of the halide solid electrolyte 201 can be further improved.

Examples of the halide solid electrolyte 201 include Li₃YX₆, Li₂MgX₄, Li₂FeX₄, Li(Al,Ga,In)X₄, and Li₃(Al,Ga,In)X₆. In this regard, X represents at least one selected from the group consisting of F, Cl, Br, and I.

In the present disclosure, the expression “(A,B,C)” in the formula means “at least one selected from the group consisting of A, B, and C”. For example, “(Al,Ga,In)” is synonymous with “at least one selected from the group consisting of Al, Ga, and In”. The same applies to other elements.

Specific examples of the halide solid electrolyte 201 containing Y include Li₃YF₆, Li₃YCl₆, Li₃YBr₆, Li₃YI₆, Li₃YBrCl₅, Li₃YBr₃Cl₃, Li₃YBr₅Cl, Li₃YBr₅I, Li₃YBr₃I₃, Li₃YBrI₅, Li₃YClI₅, Li₃YCl₃I₃, Li₃YCl₅I, Li₃YBr₂Cl₂I₂, Li₃YBrC₁₄I, Li_{2.5}Y_{0.5}Zr_{0.5}Cl₆, and Li_{2.5}Y_{0.3}Zr_{0.7}Cl₆.

There is no particular limitation regarding the shape of the sulfide solid electrolyte 202. The shape of the sulfide solid electrolyte 202 may be, for example, needlelike, spherical, ellipsoidal, or the like. For example, the shape of the sulfide solid electrolyte 202 may be granular.

There is no particular limitation regarding the shape of the odorant. The shape of the odorant may be, for example, needlelike, spherical, ellipsoidal, or the like. For example, the shape of the odorant may be granular. When the odorant is encapsulated in a microcapsule, the shape of the odorant may be, for example, gelatinous, liquid, or the like.

There is no particular limitation regarding the shape of the halide solid electrolyte 201. The shape of the halide solid electrolyte 201 may be, for example, needlelike, spherical, ellipsoidal, or the like. For example, the shape of the halide solid electrolyte 201 may be granular.

The solid electrolyte layer 102 is a layer containing a solid electrolyte. A known materials such as a solid electrolyte having lithium ion conductivity, a solid electrolyte having a sodium ion conductivity, or a solid electrolyte having magnesium ion conductivity can be used as the solid electrolyte contained in the solid electrolyte layer 102.

The solid electrolyte layer 102 may contain a solid electrolyte having lithium ion conductivity.

For example, a sulfide solid electrolyte, a halide solid electrolyte, or an oxide solid electrolyte can be used as the solid electrolyte contained in the solid electrolyte layer 102.

The above-described sulfide solid electrolyte 202 can be used as the sulfide solid electrolyte.

The above-described halide solid electrolyte 201 can be used as the halide solid electrolyte.

Examples of the oxide solid electrolyte include NASICON-type solid electrolytes represented by LiTi₂(PO₄)₃ and element-substituted products thereof, (LaLi)TiO₃-based perovskite-type solid electrolytes, LISICON-type solid electrolytes represented by Li₁₄ZnGe₄O₁₆, Li₄SiO₄, and LiGeO₄ and element-substituted products thereof, garnet-type solid electrolytes represented by Li₇La₃Zr₂O₁₂ and element-substituted products thereof, Li₃N and H-substituted products thereof, Li₃PO₄ and N-substituted products thereof, and glass or glass ceramics in which a material such as Li₂SO₄, Li₂CO₃, or the like is added to a base material containing a Li—B—O compound such as LiBO₂ or Li₃BO₃.

The thickness of the solid electrolyte layer 102 may be greater than or equal to 5 μm and less than or equal to 150 μm. When the thickness of the solid electrolyte layer 102 is greater than or equal to 5 μm, a short-circuit between the positive electrode active material layer 101 and the negative electrode active material layer 103 does not readily occur. When the thickness of the solid electrolyte layer 102 is less than or equal to 150 μm, the battery 10 can function with a high output.

The positive electrode active material layer 101 is a layer containing a positive electrode active material. The positive electrode active material layer 101 may contain a solid electrolyte. Regarding the solid electrolyte, the solid electrolyte described with respect to the solid electrolyte layer 102 can be used.

Regarding the positive electrode active material, a material having characteristics of occluding and releasing a lithium ion, a sodium ion, or a magnesium ion can be used.

When the positive electrode active material is a material having characteristics of occluding and releasing a lithium ion, for example, a lithium cobalt complex oxide (LCO), a lithium nickel complex oxide (LNO), a lithium manganese complex oxide (LMO), a lithium-manganese-nickel complex oxide (LMNO), a lithium-manganese-cobalt complex oxide (LMCO), a lithium-nickel-cobalt complex oxide (LNCO), or a lithium-nickel-manganese-cobalt complex oxide (LNMCO) can be used as the positive electrode active material.

There is no particular limitation regarding the shape of the positive electrode active material. The shape of the positive electrode active material may be, for example, needlelike, spherical, ellipsoidal, or the like. For example, the shape of the positive electrode active material may be granular.

The thickness of the positive electrode active material layer 101 may be greater than or equal to 5 μm and less than or equal to 150 μm. When the thickness of the positive electrode active material layer 101 is greater than or equal to 5 μm, a sufficient energy density of the battery 10 can be ensured. When the thickness of the positive electrode active material layer 101 is less than or equal to 150 μm, the battery 10 can function with a high output.

The negative electrode active material layer 103 is a layer containing a negative electrode active material. The negative electrode active material layer 103 may contain a solid electrolyte. Regarding the solid electrolyte, the solid electrolyte described with respect to the solid electrolyte layer 102 can be used.

Regarding the negative electrode active material, a material having characteristics of occluding and releasing a lithium ion, a sodium ion, or a magnesium ion can be used.

When the negative electrode active material is a material having characteristics of occluding and releasing a lithium ion, for example, a metal material, a carbon material, an oxide, a nitride, a tin compound, or a silicon compound can be used as the negative electrode active material. The metal material may be a simple metal. The metal material may be an alloy. Examples of the metal include a lithium metal and lithium alloys. Examples of the carbon material include natural graphite, artificial graphite, graphite fiber, and resin-heat-treated carbon. Examples of the oxide include oxides of lithium and transition metal elements.

There is no particular limitation regarding the shape of the negative electrode active material. The shape of the negative electrode active material may be, for example, needlelike, spherical, ellipsoidal, or the like. For example, the shape of the negative electrode active material may be granular.

The thickness of the negative electrode active material layer 103 may be greater than or equal to 5 μm and less than or equal to 150 μm. When the thickness of the negative electrode active material layer 103 is greater than or equal to 5 μm, a sufficient energy density of the battery 10 can be ensured. When the thickness of the negative electrode active material layer 103 is less than or equal to 150 μm, the battery 10 can function with a high output.

The battery 10 is typically a solid-state battery containing no electrolyte solution.

To improve the adhesiveness between particles, a binder may be contained in at least one selected from the group consisting of the positive electrode active material layer 101, the solid electrolyte layer 102, and the negative electrode active material layer 103. Examples of the binder include polyvinylidene fluorides, polytetrafluoroethylenes, polyethylenes, polypropylenes, aramid resins, polyamides, polyimides, polyimide-imides, polyacrylonitriles, polyacrylic acids, polyacrylic acid methyl esters, polyacrylic acid ethyl esters, polyacrylic acid hexyl esters, polymethacrylic acids, polymethacrylic acid methyl esters, polymethacrylic acid ethyl esters, polymethacrylic acid hexyl esters, polyvinyl acetates, polyvinylpyrrolidones, polyethers, polyether sulfones, hexafluoropolypropylenes, styrene-butadiene rubbers, and carboxymethyl celluloses. In addition, copolymers of at least two selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can be used as the binder. In this regard, a mixture of at least two selected from the above-described materials may be used as the binder.

To improve the electron conductivity, a conductive auxiliary agent may be contained in at least one selected from the group consisting of the positive electrode active material layer 101, the solid electrolyte layer 102, and the negative electrode active material layer 103. Regarding the conductive auxiliary agent, a conductive material such as acetylene black, carbon black, graphite, or carbon fiber can be used.

Examples of the shape of the battery 10 according to the first embodiment include a coin type, a cylindrical type, a square type, a sheet type, a button type, a flat type, and a stacked type.

### Battery Producing Method

The battery 10 according to the present embodiment can be produced by, for example, the following method. The following method is an example in which the solid electrolyte layer 102 contains the sulfide solid electrolyte 202 as the odorant.

A positive electrode material containing a positive electrode active material, a negative electrode material containing a negative electrode active material, and a solid electrolyte material containing the halide solid electrolyte 201 and the sulfide solid electrolyte 202 are prepared. Regarding the solid electrolyte material, the halide solid electrolyte 201 and the sulfide solid electrolyte 202 may be mixed in advance.

The positive electrode material, the solid electrolyte material, and the negative electrode material are stacked in this order, and pressure forming is performed. Consequently, the battery 10 including the positive electrode active material layer 101, the solid electrolyte layer 102, and the negative electrode active material layer 103 in this order is obtained. The battery 10 can also be obtained by stacking the negative electrode material, the solid electrolyte material, and the positive electrode material in this order and performing pressure forming.

### Second Embodiment

A second embodiment will be described below. The same explanations as that in the first embodiment are appropriately omitted.

FIG. 2 is a schematic sectional view illustrating the configuration of a solid-state battery 20 according to the second embodiment. In the present disclosure, “solid-state battery” means a battery including a solid electrolyte. The solid-state battery is typically an all-solid-state battery containing no electrolyte solution.

The solid-state battery 20 according to the second embodiment includes a casing 40 having an internal space 41, a power generator 30 disposed in the internal space 41, and an odorant 401 disposed outside the power generator 30 in the internal space 41.

According to the above-described configuration, for example, leakage of the electrolyte and the like from the power generator 30 can be detected early using the odorant 401. When leakage is detected, charge or discharge of the solid-state battery 20 is promptly stopped, and the occurrence of the malfunction can be notified to the outside. Therefore, the safety of the solid-state battery 20 can be improved.

The power generator 30 includes a positive electrode active material layer 301, a negative electrode active material layer 303, and a solid electrolyte layer 302 located between the positive electrode active material layer 301 and the negative electrode active material layer 303.

The solid-state battery 20 further includes a first collector 501 disposed on the power generator 30 and a second collector 502 disposed under the power generator 30. The first collector 501 is a positive electrode collector and is disposed on the positive electrode active material layer 301. The second collector 502 is a negative electrode collector and is disposed under the negative electrode active material layer 303.

In the present embodiment, the odorant 401 is disposed on the first collector 501. As described above, the odorant 401 may be disposed on the first collector 501. According to the above-described configuration, the odorant 401 does not readily affect the characteristics of the solid-state battery 20.

The odorant 401 may be solid. According to the above-described configuration, since the odorant 401 does not readily permeate the power generator 30, the odorant 401 does not readily affect the characteristics of the solid-state battery 20.

The odorant 401 has the shape of a thin film on the first collector 501. The odorant 401 having the shape of a thin film covers, for example, the entire upper surface of the first collector 501. According to the above-described structure, the amount of the odorant 401 is minimized, and an increase in the thickness of the solid-state battery 20 can be readily avoided. In this regard, the odorant 401 may cover only a portion of the upper surface of the first collector 501.

In the present embodiment, the first collector 501 and the second collector 502 are the positive electrode collector and the negative electrode collector, respectively. That is, the odorant 401 is disposed on the positive electrode collector. In this regard, the odorant 401 may be disposed on the negative electrode collector. The odorant 401 may be disposed on only the first collector 501, may be disposed on only the second collector 502, or may be disposed on the first collector 501 and the second collector 502.

Alternatively, the odorant 401 may be disposed in contact with the side surface (surface not in contact with the collector) of the power generator 30. In such an instance, an increase in the thickness of the solid-state battery 20 due to the odorant 401 can be avoided.

The odorant 401 may contain a sulfide solid electrolyte. The sulfide solid electrolyte has a function of improving the output characteristics of the solid-state battery. Consequently, according to the above-described configuration, the performance of the solid-state battery 20 can be suppressed from deteriorating due to the odorant 401 being added. Therefore, the safety of the solid-state battery 20 can be improved while the performance of the solid-state battery 20 is maintained.

The sulfide solid electrolyte 202 described in the first embodiment can be used as the sulfide solid electrolyte.

The odorant 401 may contain only the sulfide solid electrolyte. Herein, “contain only the sulfide solid electrolyte” means that a material other than the sulfide solid electrolyte except for incidental impurities is intentionally not contained in the odorant 401. Examples of the incidental impurity include raw materials of the sulfide solid electrolyte and by-products generated during production of the sulfide solid electrolyte.

When the odorant 401 contains the sulfide solid electrolyte, the ratio of the mass of the sulfide solid electrolyte to the mass of the power generator 30 may be less than or equal to 1%, may be less than or equal to 0.1%, or may be less than or equal to 0.01%.

The odorant 401 may be a material other than the sulfide solid electrolyte. Regarding the odorant 401 other than the sulfide solid electrolyte, the material described in the first embodiment can be used.

The odorant 401 may contain only a material other than the sulfide solid electrolyte. Herein, “contain only a material other than the sulfide solid electrolyte” means that the sulfide solid electrolyte except for incidental impurities is intentionally not contained in the odorant 401.

When the odorant 401 contains a material other than the sulfide solid electrolyte, the ratio of the mass of the material other than the sulfide solid electrolyte to the mass of the power generator 30 is less than or equal to 1%.

The first collector 501 and the second collector 502 are made of a conductive material such as metal. Examples of the metal include copper, aluminum, nickel, iron, platinum, and gold and alloys of these. The first collector 501 and the second collector 502 may have foil shape, a plate-like shape, a network shape, or the like. The thickness of the first collector 501 and the second collector 502 are, for example, greater than or equal to 5 μm and less than or equal to 100 μm.

The power generator 30 may contain a halide solid electrolyte. According to the above-described configuration, the safety of the solid-state battery 20 can be further improved.

At least one layer selected from the group consisting of the positive electrode active material layer 301, the negative electrode active material layer 303, and the solid electrolyte layer 302 may contain a halide solid electrolyte. The halide solid electrolyte 201 described in the first embodiment can be used as the halide solid electrolyte.

The solid electrolyte layer 302 is a layer containing a solid electrolyte. Regarding the solid electrolyte contained in the solid electrolyte layer 302, the solid electrolyte described with respect to the solid electrolyte layer 102 in the first embodiment can be used.

The positive electrode active material layer 301 is a layer containing a positive electrode active material. Regarding the positive electrode active material, the positive electrode active material described with respect to the positive electrode active material layer 101 in the first embodiment can be used. The positive electrode active material layer 301 may contain a solid electrolyte. Regarding the solid electrolyte, the solid electrolyte described with respect to the solid electrolyte layer 102 in the first embodiment can be used.

The negative electrode active material layer 303 is a layer containing a negative electrode active material. Regarding the negative electrode active material, the negative electrode active material described with respect to the negative electrode active material layer 103 in the first embodiment can be used. The negative electrode active material layer 303 may contain a solid electrolyte. Regarding the solid electrolyte, the solid electrolyte described with respect to the solid electrolyte layer 102 in the first embodiment can be used.

The thickness of each of the positive electrode active material layer 301, the negative electrode active material layer 303, and the solid electrolyte layer 302 is as described with respect to the positive electrode active material layer 101, the negative electrode active material layer 103, and the solid electrolyte layer 102, respectively, in the first embodiment.

To improve the adhesiveness between particles, a binder may be contained in at least one of the positive electrode active material layer 301, the solid electrolyte layer 302, and the negative electrode active material layer 303. Regarding the binder, the binder described in the first embodiment can be used.

To improve the electron conductivity, a conductive auxiliary agent may be contained in at least one of the positive electrode active material layer 301, the solid electrolyte layer 302, and the negative electrode active material layer 303. Regarding the conductive auxiliary agent, the conductive auxiliary agent described in the first embodiment can be used.

The casing 40 is a hollow container in which the power generator 30 can be disposed in the internal space 41. The casing 40 in the present embodiment has a substantially rectangular parallelepiped shape. The casing 40 may be formed using a metal material or may be formed using a resin material. The casing 40 may be formed using, typically, a multilayer body obtained by stacking two layers of resin films and metal film disposed between the resin films. The multilayer body can be, typically, an aluminum laminate film.

Examples of the shape of the solid-state battery 20 according to the second embodiment include a coin type, a cylindrical type, a square type, a sheet type, a button type, a flat type, and a stacked type.

### Solid-State Battery Producing Method

The solid-state battery 20 according to the present embodiment can be produced by, for example, the following method.

A positive electrode material containing a positive electrode active material, a negative electrode material containing a negative electrode active material, a solid electrolyte material, the first collector 501 serving as the positive electrode collector, and the second collector 502 serving as the negative electrode collector are prepared.

The positive electrode material, the solid electrolyte material, the negative electrode material, and the second collector 502 are stacked in this order on the first collector 501, and pressure forming is performed. Consequently, a multilayer body including the power generator 30 provided with the positive electrode active material layer 301, the solid electrolyte layer 302, and the negative electrode active material layer 303 in this order is obtained. Such a multilayer body can also be obtained by stacking the negative electrode material, the solid electrolyte material, the positive electrode material, and the first collector 501 in this order on the second collector 502 and performing pressure forming.

The resulting multilayer body is disposed in the internal space 41 of the casing 40 with the second collector 502 below the first collector 501. The odorant 401 is disposed on the multilayer body, that is, on the first collector 501. As a result, the solid-state battery 20 can be obtained.

The battery and the solid-state battery according to the present disclosure can be utilized as, for example, an all-solid-state lithium secondary battery.

What is claimed is:

1. A battery comprising:
a positive electrode active material layer;
a negative electrode active material layer; and
a solid electrolyte layer located between the positive electrode active material layer and the negative electrode active material layer,
wherein Requirement (i) or Requirement (ii) below is satisfied,
(i) at least one layer selected from the group consisting of the positive electrode active material layer, the negative electrode active material layer, and the solid electrolyte layer contains a halide solid electrolyte and a sulfide solid electrolyte, and
a ratio of the mass of the sulfide solid electrolyte to a total mass of the positive electrode active material layer, the negative electrode active material layer, and the solid electrolyte layer is less than or equal to 1%, or
(ii) at least one layer selected from the group consisting of the positive electrode active material layer, the negative electrode active material layer, and the solid electrolyte layer contains a halide solid electrolyte and an odorant, and
a ratio of the mass of the odorant to a total mass of the positive electrode active material layer, the negative electrode active material layer, and the solid electrolyte layer is less than or equal to 1%.

2. The battery according to claim 1,
wherein, regarding Requirement (i), the ratio of the mass of the sulfide solid electrolyte to the total mass of the positive electrode active material layer, the negative electrode active material layer, and the solid electrolyte layer is less than or equal to 0.1%.

3. The battery according to claim 1,
wherein, regarding Requirement (i), the ratio of the mass of the sulfide solid electrolyte to the total mass of the positive electrode active material layer, the negative electrode active material layer, and the solid electrolyte layer is less than or equal to 0.01%.

4. The battery according to claim 1,
wherein, regarding Requirement (i), the sulfide solid electrolyte contains at least one selected from the group consisting of Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

5. The battery according to claim 1,
wherein, regarding Requirement (ii), the odorant is a substance having no lithium ion conductivity.

6. The battery according to claim 1,
wherein the halide solid electrolyte contains at least one selected from the group consisting of Li, metal elements other than Li, and semimetals and at least one selected from the group consisting of F, Cl, Br, and I.

7. The battery according to claim 6,
wherein the halide solid electrolyte is denoted by Formula (1):
L_{α}M_{β}X_{γ} (1)
where α, β, and γ each represent a value greater than 0,
M represents at least one selected from the group consisting of metal elements other than Li and semimetals, and
X represents at least one selected from the group consisting of F, Cl, Br, and I.

8. The battery according to claim 7,
wherein, in Formula (1), M includes yttrium.

9. A solid-state battery comprising:
a casing having an internal space;
a power generator disposed in the internal space, and
an odorant disposed outside the power generator in the internal space.

10. The solid-state battery according to claim 9,
wherein the odorant is solid.

11. The solid-state battery according to claim 9,
wherein the odorant contains a sulfide solid electrolyte.

12. The solid-state battery according to claim 9, further comprising:
a first collector disposed on the power generator; and
a second collector disposed under the power generator,
wherein the odorant is disposed on the first collector.
